(19) United States
(12) Patent Application Publication
(10) Pub. No.: US 2007/0276627 A1
(43) Pub. Date: Nov. 29, 2007

(54) Repair determination for heat damaged composite structures

(76) Inventor: Everett A. Westerman, Auburn, WA (US)

Correspondence Address: KLEIN, O'NEILL & SINGH, LLP, 43 CORPORATE PARK, SUITE 204, IRVINE, CA, 92606, US

(21) Appl. No.: 11/440,742

(22) Filed: May 25, 2006

(51) Int. Cl. G01N 21/00

(52) U.S. Cl. 702/184; 702/34

(57) ABSTRACT

A system and method for assessing the ability to rework a composite structure with a heat induced inconsistency is provided. The method includes acquiring information related to the composite structure with a heat induced inconsistency; comparing the information of the composite structures with a heat induced inconsistency with heat induced inconsistency assessment signatures stored in a look up table; correlating the output of the compared information with material master curves; analyzing the composite structures with a heat induced inconsistency to determine the remaining structural capability; determining if the composite structures with a heat induced inconsistency requires immediate rework or replacement; and displaying the results.

### CROSS REFERENCE TO RELATED APPLICATIONS

NONE

### BACKGROUND

1. Field of Invention

This invention relates generally to composite structures, and more particularly, to determining the remaining life of damaged composite structures.

2. Background of the Invention

Increasingly components and structures for aircrafts are being made of composite materials. These composite structures are susceptible to many forms of damage, including heat, de-lamination, puncture, scrapes and gouges. With the exception of heat damage, there are established procedures to address damaged composite structures.

It is not uncommon for aircraft composite structures (may also be referred to as “parts” or “components”) to be exposed to elevated temperature conditions. Composite parts heat up when the aircraft is subjected to various situations such as lightning strikes, fires within the fuselage, wing structure and landing gear wells, heat impingement due to numerous or improper bonded repairs, damaged thrust reversers, and broken hot air ducts. These elevated temperatures can induce reduced structural capability and impact overall airworthiness of the aircraft.

Although the foregoing problem is illustrated with respect to aircrafts, similar problems can exist in other assemblies (for example, ships, space shuttle, automobiles and others).

Current damage assessment techniques can detect structural defects but cannot predict the remaining life of a part or the part's ability to perform its design function. Typically, all heat damaged composite structures are immediately repaired or replaced. In some instances, the repair or replacement may be pre-mature. This can result in monetary loss because an aircraft can be grounded for repairs, when it may not need the repairs. Also, a component is under utilized when it is replaced before its service life is over.

A repair or the ability to confidently defer the repair or replacement of a damaged composite structure until a major maintenance check would result in increased revenue and a decrease in unneeded repairs. In view of the above, what is needed is a method and system for assessing damage to a composite structure to determine the remaining life of the structure.

### SUMMARY OF THE INVENTION

In one aspect of the present invention, a method for assessing the reparability of heat damage to a composite structure is provided. The method includes acquiring information related to the damaged composite structure; comparing the information of the damaged composite structure with damage assessment signatures stored in a look up table; correlating the output of the compared information with material master curves; analyzing the damaged structure to determine the remaining structural capability; determining if the damaged composite structure requires immediate repair or replacement; and displaying the results of the repairable damage.

In another aspect of the present invention, a system for assessing the reparability of heat damage to a composite structure is provided. The system includes an analysis module; a database; a compare module that communicates with a look up table in the database for comparing information of the damaged composite structure with damage assessment signatures in the look up table; and an output module, in communication with an output interface module within the analysis module, for displaying any matches.

In yet another aspect of the present invention, computer-executable process steps stored on a computer-readable medium, the computer-executable process steps for assessing the reparability of heat damage to a composite structure, the computer-executable process steps executable to perform a method comprising: acquiring information related to the damaged composite structure; comparing the information of the damaged composite structure with damage assessment signatures stored in a look up table; correlating the output of the compared information with material master curves; analyzing the damaged structure to determine the remaining structural capability; determining if the damaged composite structure requires immediate repair or replacement; and displaying the results of the damage assessment.

This brief summary has been provided so that the nature of the invention may be understood quickly. A more complete understanding of the invention can be obtained by reference to the following detailed description of the preferred embodiments thereof in connection with the attached drawings.

### BRIEF DESCRIPTION OF THE DRAWINGS

The foregoing features and other features of the present invention will now be described with reference to the drawings of a preferred embodiment. The illustrated embodiment is intended to illustrate, but not to limit the invention. The drawings include the following:

FIG. 1 shows a block diagram of a computing system for executing process steps, according to one aspect of the present invention;

FIG. 2 shows the internal architecture of the computing system of FIG. 1;

FIG. 3A shows a block diagram of a system for assessing the damage to a composite structure, according to one aspect of the present invention;

FIG. 3B shows a lookup table in a database, according to one aspect of the present invention;

FIG. 3C is an example of a material master curve showing the performance of a composite material exposed to heat over a given time period;

FIG. 4 is a flow diagram showing the steps of populating the database, according to one aspect of the present invention; and

FIG. 5 is a flow diagram showing the steps of assessing the damage and determining needed repairs to a composite structure, according to one aspect of the present invention.

### DETAILED DESCRIPTION OF THE PREFERRED EMBODIMENTS

The present invention provides an automated method/system for assessing damage to a composite structure. The system can be implemented in software and executed by a computing system. To facilitate an understanding of the preferred embodiment, the general architecture and operation of a computing system will be described first. The specific process under the preferred embodiment will then be described with reference to the general architecture.

Computing System:

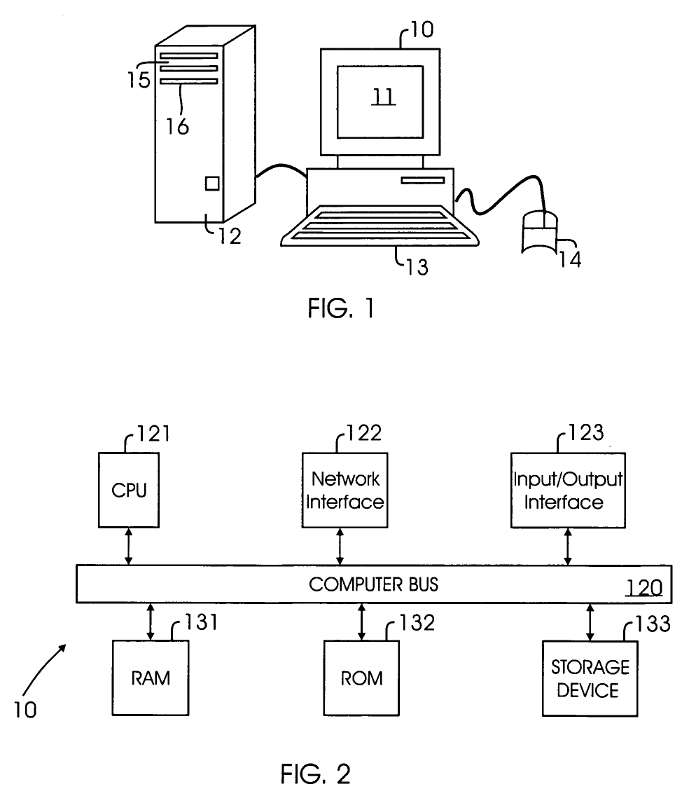

FIG. 1 is a block diagram of a computing system for executing computer executable process steps according to one aspect of the present invention. FIG. 1 includes a host computer 10 and a monitor 11. Monitor 11 may be a CRT type, a LCD type, or any other type of color or monochrome display.

Also provided with computer 10 are a keyboard 13 for entering data and user commands, and a pointing device (for example, a mouse) 14 for processing objects displayed on monitor 11.

Computer 10 includes a computer-readable memory storage device 15 for storing readable data. Besides other programs, storage device 15 can store application programs including web browsers and computer executable code, according to the present invention.

According to one aspect of the present invention, computer 10 can also access computer-readable removable storage device storing data files, application program files, and computer executable process steps embodying the present invention or the like via a removable memory device 16 (for example, a CD-ROM, CD-R/W, flash memory device, zip drives, floppy drives and others).

A modem, an integrated services digital network (ISDN) connection, or the like also provide computer 10 with a network connection 12 to the World Wide Web (WWW), to the intranet—the network of computers within a company or entity within the company, or to the aircraft itself. The network connection 12 allows computer 10 to download data files, application program files and computer-executable process steps embodying the present invention.

It is noteworthy that the present invention is not limited to the FIG. 1 architecture. For example, notebook or laptop computers, or any other system capable of connecting to a network and running computer-executable process steps, as described below, may be used to implement the various aspects of the present invention.

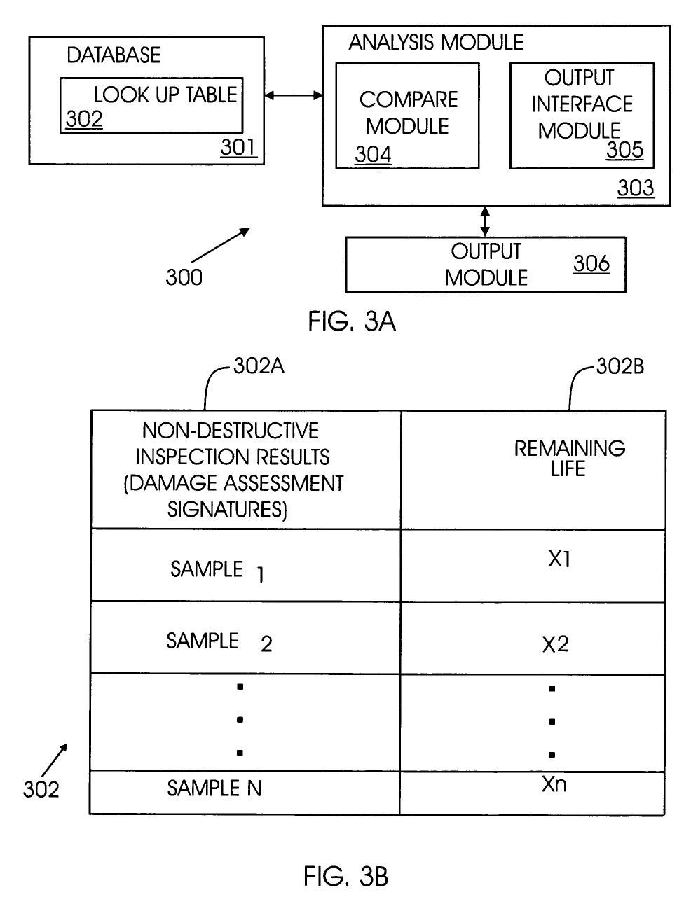

FIG. 2 shows a top-level block diagram showing the internal functional architecture of computing system 10 that may be used to execute the computer-executable process steps, according to one aspect of the present invention. As shown in FIG. 2, computing system 10 includes a central processing unit (CPU) 121 for executing computer-executable process steps and interfaces with a computer bus 120.

Also shown in FIG. 2 are an input/output interface 123 that operatively connects output display device such as monitors 11, input devices such as keyboards 13 and a pointing device such as a mouse 14.

A storage device 133 (similar to device 15) also interfaces to the computing device 10 through the computer bus 120. Storage device 133 may be disks, tapes, drums, integrated circuits, or the like, operative to hold data by any means, including magnetically, electrically, optically, and the like. Storage device 133 stores operating system program files, application program files, computer-executable process steps of the present invention, web-browsers and other files. Some of these files are stored on storage device 133 using an installation program. For example, CPU 121 executes computer-executable process steps of an installation program so that CPU 121 can properly execute the application program.

Random access memory (“RAM”) 131 also interfaces with computer bus 120 to provide CPU 121 with access to memory storage. When executing stored computer-executable process steps from storage device 133, CPU 121 stores and executes the process steps out of RAM 131.

Read only memory (“ROM”) 132 is provided to store invariant instruction sequences such as start-up instruction sequences or basic input/output operating system (BIOS) sequences.

The computing system 10 can be connected to other computing systems through the network interface 122 using computer bus 120 and a network connection (for example 12). The network interface 122 may be adapted to one or more of a wide variety of networks, including local area networks, storage area networks, wide area networks, the Internet, and the like.

In one aspect of the invention, composite assessment software may be supplied on a CD-ROM or a floppy disk or alternatively could be read from the network via a network interface 122. In yet another aspect of the invention, the computing system 10 can load the composite assessment software from other computer readable media such as magnetic tape, a ROM, integrated circuit, or a magneto-optical disk.

Alternatively, the composite assessment software is installed onto the storage device 133 of the computing system 10 using an installation program and is executed using the CPU 121.

In yet another aspect, the composite assessment software may be implemented by using an Application Specific Integrated Circuit that interfaces with computing system 10.

According to the present invention, a method and system for assessing heat damage to a composite structure is provided. Although the system and method of the present invention are implemented using an aircraft, those skilled in the art will recognize that the principles and teachings described herein may be applied to a variety of structures made with composite materials, such as automobiles, trains and ships.

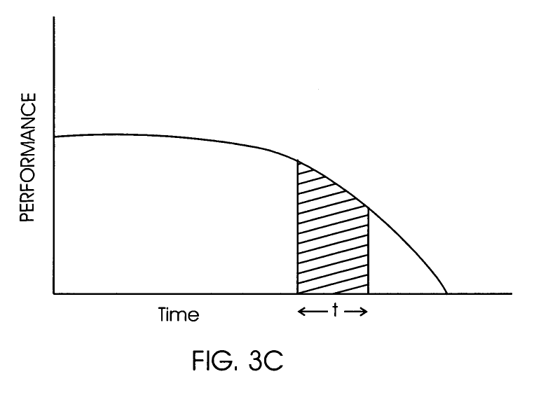

FIG. 3A shows a block diagram of a system 300 for assessing the damage to a composite structure. System 300 comprises a database 301 having a look up table 302 containing photographs of fabricated heat damaged composite structural component (or “structure”) samples. A photograph or picture of the damaged structure is taken creating a damage assessment signature for that particular damaged structure. The damage assessment signature shows the degradation or decay of a known composite structure when exposed to heat for a known amount of time. Damage assessment signatures are obtained at various temperatures, such as 350° F., 400° F., 450° F., 500° F., 550° F. and 600° F.

When fabricating the damaged structure samples, the damage assessment signatures can be obtained from a variety of nondestructive inspection (NDI) techniques commonly applied to aircraft structures to determine heat degenerative anomalies (charring, delamination, voids, material softening etc.) and physical material degradation in structural components. These techniques include transmission ultrasonics, pulse echo ultrasonics, lamb wave UT, high frequency eddy current, laser fluorescence, hardness testers and microwave inverse scattering.

In a preferred embodiment of the present invention, microwave inverse scattering is utilized. This technique measures degradation of the bulk matrix material and discrete anomalies in a composite structure. The dielectric characteristics of a composite structure can change as the result of chemical composition or physical change. These changes can result from excessive heating, curing, hardening, residual stress and temperature gradients. By knowing the changes in a value of a known dielectric constant, characteristics related to heat damage can be determined. This technique uses the measurement of a scattered microwave energy field to determine dielectric constants in a material that relate to its polymerization.

Turning back to FIG. 3A, an analysis module 303 is coupled to database 301. A compare module 304, within analysis module 303, compares a heat damaged composite structure to the damage assessment signatures in look up table 302. Comparison occurs by overlaying the picture of the heat damaged composite structure with the damaged structure in look up table 302 or by a comparison of performance data. Once the comparison is completed, any matches that were obtained are communicated to an output module 306 via an output interface module 305 within analysis module 303. Output module 306 may be any device with a monitor or any device capable of receiving a communication.

A match occurs when the picture of the heat damaged composite structure is the same as, or similar to, (i.e. has a certain number of characteristics in common determined by the user of the system) a damage assessment signature in look up table 302. The number of matches that can occur is not limited. Once a list of possible matches is generated, the user manually filters (or compares) each match in the list to the picture of the heat damaged composite structure. By manually filtering each match, the user can determine the damage assessment signature that most closely matches the picture of the heat damaged structure.

It is noteworthy that the foregoing modular structure of system 300 is simply to illustrate the adaptive aspects of the present invention. The various modules can be integrated into a single piece of code, subdivided into further sub-modules or implemented in an ASIC. System 300 can be implemented in a computing system similar to computing system 10.

FIG. 3B shows lookup table 302 in database 301 which stores the damage assessment signatures of the fabricated heat damaged structures, according to one aspect of the present invention. Look up table 302 comprises a first column 302A and a second column 302B. First column 302A lists NDI test results, i.e. the damage assessment signatures, of the fabricated heat damaged structures and second column 302B lists the corresponding remaining life of the damaged composite structures.

FIG. 3C is an example of a material master curve showing the performance of a material exposed to heat over a given time period. As can be seen in the graph, the performance of the material slowly degrades or decays the longer the material is subjected to heat. The graph displays a window or time frame “t” in which the material's performance is still acceptable despite the degradation or decay. When the performance of the material is beyond time frame “t”, the performance of the material is unacceptable.

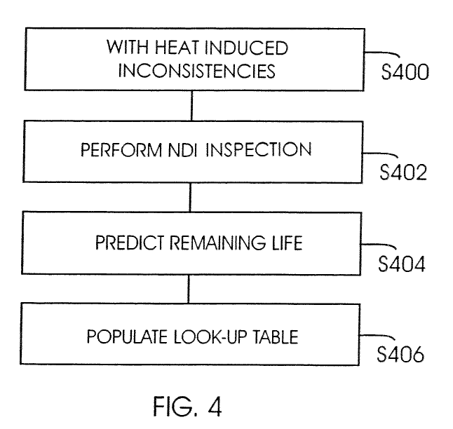

FIG. 4 is a flow diagram showing the steps of populating database 301, according to one aspect of the present invention. In step S400, heat damaged structure samples are fabricated by applying heat to accelerate the life of the materials and damage the structure. Instead of looking at what happens to a material in 10 years, the material is assessed after a specific number of hours of use, such as 100 hours. In step S401, a NDI inspection of the fabricated damaged structure is performed and photographs/pictures of the fabricated damaged structure are taken. The NDI inspection is performed using techniques that are well known in the art, such as those described above. In step S402, the NDI signature assessments are correlated with known material aging results, i.e. the material master curves, of the material, used in the composite structure to ensure the fabricated damage is accurate. In step S403, the remaining life of the damage structure is predicted based on the correlation in step S402. In step S404, the damaged structure samples are tested to verify the remaining life. In step S405, database 301 is populated with the damage assessment signatures of the fabricated heat damaged structures.

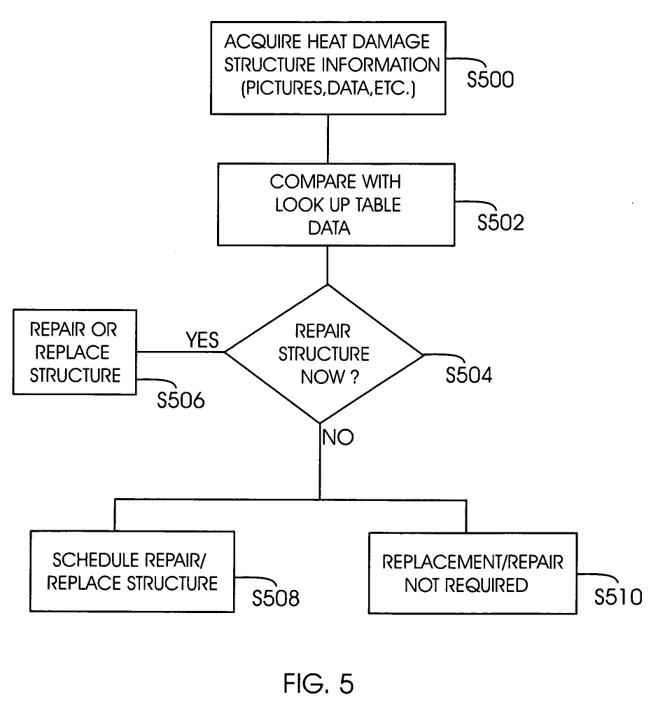

FIG. 5 is a flow diagram showing the steps of assessing the damage and determining needed repairs to a composite structure, according to one aspect of the present invention. In step S500, information about a heat damaged composite structure is acquired. This information may include, but is not limited to, photographs/pictures and performance data.

In step S501, the photograph of a heat damaged structure is compared to damage assessment signatures in look up table 302 to determine if there are any matches. Comparison occurs by overlaying the picture of the heat damaged composite structure with the damaged structured in look up table 302 or by a comparison of data. A match occurs when the picture of the heat damaged composite structure is the same as, or similar to, (i.e. has a certain number of characteristics in common determined by the user of the system) a damage assessment signature in look up table 302. The number of matches that can occur is not limited. Once a list of possible matches is generated, the user can manually filter (or compare) each match in the list to the picture of the heat damaged composite structure. By manually filtering each match, the user can determine the damage assessment signature that most closely matches the picture of the heat damaged structure.

In step S502, the output of step S501 is correlated with the material master curve. In other words, if a match occurs in step S501, the performance data of the damaged structure is compared with the performance data in the material master curves to determine the remaining life of the damaged structure.

In step S503, the remaining structural capability of the structure is analyzed by techniques well known in the art. In step S504, a determination is made as to whether the structure requires immediate repair or if the repair can be deferred based on the analysis in step S503. In step S505, the damaged structure is repaired or replaced if there was a determination in step S504 that repair or replacement should be performed immediately. In step S506, repair or replacement of the damaged structure is deferred as it has been determined that the damaged structure has not degraded or decayed to a point where repair or replacement is necessary as the structure will still perform its design function. In step S507, repair or replacement of the damaged structure is not required.

While the present invention is described above with respect to what is currently considered its preferred embodiments, it is to be understood that the invention is not limited to that described above. To the contrary, the invention is intended to cover various modifications and equivalent arrangements within the spirit and scope of the appended claims.

1. A method for assessing the ability to rework a composite stricture with a heat induced inconsistency, the method comprising:
acquiring information related to the composite structure with a heat induced inconsistency;
comparing the information of the composite structure with damage a heat induced inconsistency with heat induced inconsistency assessment signatures stored in a look up table;
correlating the output of the compared information with material master curves;
analyzing the composite structure with a heat induced inconsistency to determine the remaining service life;
determining if the composite structure with a heat induced inconsistency requires immediate rework or replacement; and displaying the results.

2. The method of claim, further comprising:
creating the heat induced inconsistency assessment signatures comprising:
fabricating an composite structures with a heat induced inconsistency;
inspecting the composite structures with a heat induced inconsistency; and
photographing the composite structures with a heat induced inconsistency.

3. The method of claim 1, wherein the information is in the form of photographs

4. The method of claim 2, wherein the composite structure with heat induced inconsistency is inspected using a non-destructive inspection technique.

5. The method of claim 3, wherein the information is compared by overlaying a picture of the composite structure with heat induced inconsistency on each of the heat induced inconsistency assessment signatures generating a list of possible matches.

6. The method of claim 5, wherein the list of possible matches is manually filtered to determine the closest match.

7. The method of claim 6, wherein the remaining service life of the composite structures with a heat induced inconsistency determines if the composite structures with a heat induced inconsistency requires immediate rework or replacement.

8. A system for assessing the ability to rework a composite structure with a heat induced inconsistency the system comprising:
an analysis module;
a database;
a compare module that communicates with a look up table in the database for comparing information of the composite structures with a heat induced inconsistency with heat induced inconsistency assessment signatures in the look up table; and
an output module, in communication with an output interface module within the analysis module, for displaying any matches.

9. The system of claim 8, wherein the look up table comprises a first column and a second column, where the first column lists heat induced inconsistency assessment signatures and the second column lists the corresponding remaining service life of the composite structures with a heat induced inconsistency.

10. The method of claim 9, wherein the compare module overlays a picture of the composite structures with a heat induced inconsistency on each of heat induced inconsistency assessment signature generating a list of possible matches.

11. The method of claim 10, wherein the list of possible matches is manually filtered to determine the closest match.

12. Computer-executable process steps stored on a computer-readable medium, the computer-executable process steps for assessing the ability to rework of to a composite structure with a heat induced inconsistency, the computer-executable process steps executable to perform a method comprising:
acquiring information related to the composite structures with a heat induced inconsistency;
comparing the information of the composite structures with a heat induced inconsistency with heat induced inconsistency assessment signatures stored in a look up table;
correlating the output of the compared information with material master curves,
analyzing the composite structures with a heat induced inconsistency to determine the remaining structural capability;
determining if the composite structures with a heat induced inconsistency requires immediate rework or replacement; and displaying the results of the heat induced inconsistency assessment.

13. The computer-executable process of claim 12, further comprising:
creating the heat induced inconsistency assessment signatures, comprising:
fabricating an composite structures with a heat induced inconsistency; inspecting the composite structures with a heat induced inconsistency; and
photographing the composite structures with a heat induced inconsistency.

14. The computer-executable process of claim 12, wherein the information is in the form of photographs.

15. The computer-executable process of claim 13, wherein the composite structures with a heat induced inconsistency is inspected using a non-destructive inspection technique.

16. The computer-executable process of claim 14, wherein the information is compared by overlaying a picture of the composite structures with a heat induced inconsistency on each of the heat induced inconsistency assessment signatures generating a list of possible matches.

17. The computer-executable process of claim 16, wherein the list of possible matches is manually filtered to determine the closest match.

18. The computer-executable process of claim 17, wherein the remaining service life on the composite structures with a heat induced inconsistency determines if the composite structures with a heat induced inconsistency requires immediate repair or replacement.
